(19) United States
(12) Patent Application Publication
(10) Pub. No.: US 2021/0394752 A1
(43) Pub. Date: Dec. 23, 2021

(54) Traveling Control Device, Vehicle, and Traveling Control Method

(71) Applicant: Hitachi Automotive Systems, Ltd., Hitachinaka-shi, Ibaraki (JP)

(72) Inventor: Seiichi SATOH, Hitachinaka-shi, Ibaraki (JP)

(21) Appl. No.: 17/279,687

(22) PCT Filed: Sep. 12, 2019
(86) PCT No.: PCT/JP2019/035830

§ 371 Date: Mar. 25, 2021

(30) Foreign Application Priority Data
Sep. 28, 2018 (JP) 2018-183758

(51) Int. Cl. B60W 30/095; B62D 15/02; B62D 6/04; B60W 40/04

(52) U.S. Cl. CPC B60W 30/0956; B62D 15/0265; B60T 7/12; B60W 40/04; B62D 6/04

(57) ABSTRACT

There is provided a traveling control device capable of appropriately performing collision avoidance by using not only a region inside a lane of an own vehicle but also a region outside the lane of the own vehicle. A traveling control device includes an acceleration calculation unit which obtains an acceleration of a target object from information of an outside recognition sensor, a behavior estimation unit which estimates a behavior of the target object from the acceleration, a TTC calculation unit which obtains a time to collision from the information of the outside recognition sensor, a determination unit which determines a risk region based on outputs of the TTC calculation unit and the behavior estimation unit, and a collision avoidance operation control unit which controls a collision avoidance operation for the target object based on a result of the determination unit.

### TECHNICAL FIELD

The present invention relates to a traveling control device, a vehicle, and a travel control method for controlling traveling of a vehicle.

### BACKGROUND ART

In recent years, the development of ADAS (advanced driver-assistance system) and automatic driving-related technology in vehicles has been rapidly promoted. Adaptive cruise control, lane keeping assist system, emergency automatic braking, and the like have been put into practical use as functions for automating a part of driving operations.

Although brake control has been mainly used for collision avoidance in the related art, in recent years, autonomous emergency steering avoidance (AES) control has been developed, and an in-lane steering avoidance function and a function of assisting steering avoidance of a driver has been put into practical use.

In this regard, PTL 1 discloses a traveling control device that changes a traveling route based on a collision risk with a preceding vehicle due to deceleration of the preceding vehicle.

PTL 2 discloses a driving assistance device having improved functionality that can automatically adjust an inter-vehicle distance according to a behavior of a vehicle traveling in front of an own vehicle.

### CITATION LIST

### Patent Literature

PTL 1: JP 2016-37267 A

PTL 2: JP 2011-126406 A

### SUMMARY OF INVENTION

### Technical Problem

It is an important issue to appropriately determine a steering avoidance direction according to a traffic condition around the own vehicle while emergency steering avoidance control has become widespread as automatic driving and driving assistance. In a case where the own vehicle performs steering avoidance, when another obstacle is present on an adjacent lane or an avoidance destination, a secondary accident is likely to occur.

The steering avoidance control currently in practical use is a function limited to a region inside the lane of the own vehicle, but there are cases where it is not possible to cope with only the region inside the lane of the own vehicle in some scenes in which collision avoidance is necessary. For example, when a size of a steering avoidance object is large, collision occurs unless the object popping up the lane of the own vehicle is avoided. Thus, avoidance control using free space such as adjacent lanes needs to be performed. Even when an avoidance target object moves in the same direction as the steering avoidance direction of the own vehicle, the collision is likely to occur.

Thus, an object of the present invention is to provide a traveling control device capable of appropriately performing collision avoidance by using not only a region inside a lane of an own vehicle but also a region outside the lane of the own vehicle. Another object thereof is to provide a highly safe vehicle traveling control device by appropriately controlling collision avoidance based on a behavior of an avoidance target object.

### Solution to Problem

In order to solve the problems, in the present invention, there is provided a “traveling control device including an acceleration calculation unit which obtains an acceleration of a target object from information of an outside recognition sensor, a behavior estimation unit which estimates a behavior of the target object from the acceleration, a TTC calculation unit which obtains a time to collision from the information of the outside recognition sensor, a determination unit which determines a risk region based on outputs of the TTC calculation unit and the behavior estimation unit, and a collision avoidance operation control unit which controls a collision avoidance operation for the target object based on a result of the determination unit”.

In the present invention, there is provided a “traveling control method including obtaining an acceleration of a target object from information of an outside recognition sensor, estimating a behavior of the target object from the acceleration, obtaining a time to collision, determining a risk region based on the time to collision and the behavior of the target object, and controlling a collision avoidance operation for the target object”.

### Advantageous Effects of Invention

According to the present invention, appropriate automatic steering avoidance can be achieved by performing behavior prediction based on the vehicle behavior of the avoidance target object. Thus, a collision accident including a secondary accident is prevented, and thus, a highly safe automatic driving system or a safe driving assistance system can be realized.

### BRIEF DESCRIPTION OF DRAWINGS

FIG. 1 is a block diagram illustrating an overall configuration example of a vehicle according to a first embodiment.

FIG. 2 is a diagram illustrating a processing flow in an obstacle detection unit 111 according to the first embodiment.

FIG. 3 is a diagram illustrating a processing flow of an obstacle behavior estimation unit 112 according to the first embodiment.

FIG. 4 is a diagram illustrating a processing flow of a risk region determination unit 113 according to the first embodiment.

FIG. 5 is a diagram illustrating a processing flow of a TTC calculation unit 114 and a collision avoidance operation control unit 115 according to the first embodiment.

FIG. 6 is a diagram illustrating an example of steering avoidance on an expressway.

FIG. 7 is a diagram illustrating an example of the steering avoidance on the expressway.

FIG. 8 is a diagram illustrating an example of steering avoidance at an intersection.

FIG. 9 is a diagram illustrating a processing flow of a TTC calculation unit 114 and a collision avoidance operation control unit 115 according to a second embodiment.

FIG. 10 is a diagram that summarizes a steering avoidance direction of the own vehicle corresponding to a direction and a degree of a lateral acceleration of an obstacle and a direction and a degree of a lateral velocity when the own vehicle performs steering avoidance for the obstacle.

### DESCRIPTION OF EMBODIMENTS

Hereinafter, embodiments of a traveling control device, a vehicle, and a travel control method according to the present invention will be described with reference to the drawings.

### First Embodiment

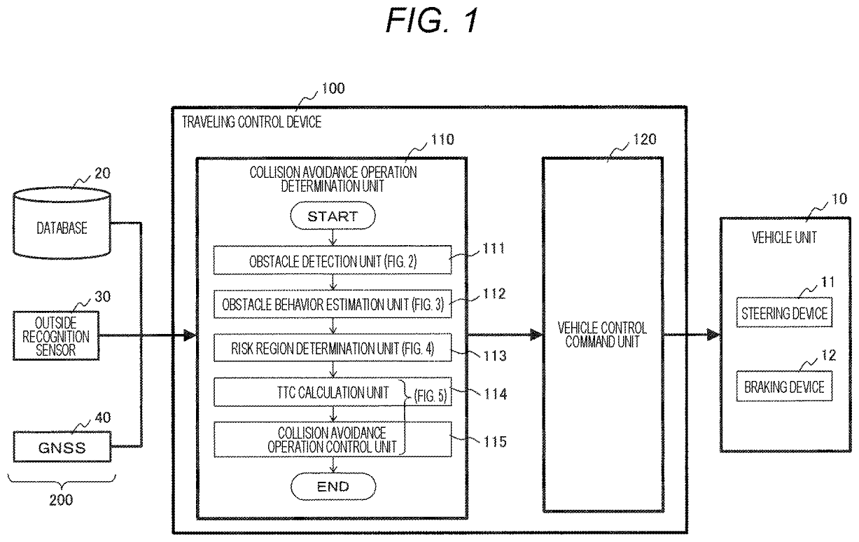

FIG. 1 is a block diagram illustrating an overall configuration example of a vehicle according to a first embodiment.

The vehicle of FIG. 1 includes a vehicle unit 10, a traveling control device 100 mounted on the vehicle, and a data input unit 200. The data input unit 200, a part or all of which are mounted on the vehicle unit 10, is a database 20 that stores map information, an outside recognition sensor 30 constituted by various sensors, and a GNSS 40 that obtains positional information. The configuration of FIG. 1 can be said to be a vehicle having the traveling control device 100 and the data input unit 200 mounted thereon.

The traveling control device 100 includes a collision avoidance operation determination unit 110 and a vehicle control command unit 120. The traveling control device 100 is generally a computer device, and includes a read only memory (ROM) for storing a traveling control algorithm, a central processing unit (CPU) for executing various kinds of arithmetic processing, a random access memory (RAM) for storing arithmetic results, and the like.

The vehicle unit 10 includes at least a steering device 11 and a braking device 12. The steering device 11 controls the steering of the vehicle according to a control command value output by the vehicle control command unit 120 in the traveling control device 100, and the braking device 12 controls the braking of the vehicle.

The steering device 11 may be configured to control a steering angle by hydraulic power steering, electric power steering, or the like. The braking device 12 may be configured to control a braking force by a hydraulic brake, an electric brake, or the like.

Although it has been described in the first embodiment illustrated in FIG. 1 that the traveling control device 100, the steering device 11, and the braking device 12 are separate devices, for example, the vehicle traveling control device 100 and the device (steering device 11 and braking device 12) of the vehicle can be combined as one device or the vehicle traveling control device 100 and only the steering device 11 (may be the braking device 12) can be combined as one device.

Signal transmission means between the traveling control device 100 and the vehicle unit 10 can transmit and receive signals by using a Controller AreaNetwork (CAN) which is generally used as an in-vehicle network.

The collision avoidance operation determination unit 110 includes an obstacle detection unit 111, an obstacle behavior estimation unit 112, a risk region determination unit 113, a time to collision (TTC) calculation unit 114, and a collision avoidance operation control unit 115, and these pieces of processing in these units are sequentially executed as pieces of digital software processing in the CPU. The pieces of digital software processing in the CPU are sequentially executed at predetermined constant control cycles.

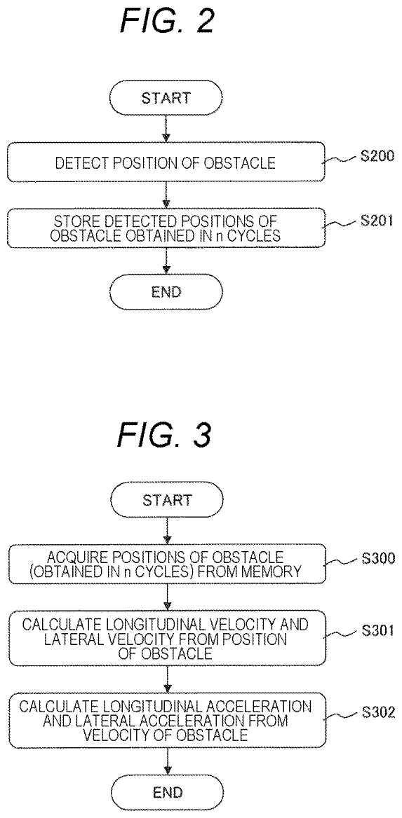

FIG. 2 illustrates a processing flow in the obstacle detection unit 111. In first processing step S200 of the obstacle detection unit 111, a position of an obstacle on a traveling path of the own vehicle is detected by detecting a traveling position of the own vehicle by using information obtained from the map database 20 and the GNSS 40 and detecting an obstacle present around the own vehicle by the outside recognition sensor 30.

The map database 20 may use a map of a navigation system or may use a map-dedicated module.

The outside recognition sensor 30 has a system configuration capable of sensing front, rear, left side, and right side in a traveling direction of the own vehicle, and a sensing system is constituted by a sensor capable of measuring a position of a target object such as a stereo camera, a monocular camera, a millimeter wave radar, or a laser radar.

In processing step S201, the obstacle behavior estimation unit 112 performs preparation stage processing for calculating a longitudinal velocity, a lateral velocity, a longitudinal acceleration, and a lateral acceleration, and temporarily stores positional information including a current obstacle position obtained in n cycles in the past in a memory. However, n (n=1, 2, 3, . . . ) is arbitrary. The lateral acceleration or the lateral velocity means an acceleration or a velocity in a direction orthogonal to the traveling direction of the own vehicle, and can be said to be, in other words, a direction orthogonal to a lane direction.

Here, when the outside recognition sensor 30 outputs not only the position of the obstacle but also a velocity of the obstacle, velocity information of the obstacle may be temporarily stored in the memory.

FIG. 3 illustrates a processing flow of the obstacle behavior estimation unit 112. In first processing step S300 of the obstacle behavior estimation unit 112, the positional information of the obstacle (obtained in n cycles in a control cycle) detected by the obstacle detection unit 111 is acquired from the memory.

In processing step S301, the velocity of the obstacle is calculated based on the positional information acquired in processing step S300. At this time, a moving direction of the vehicle can be known by obtaining the amount of change between a position at a current point in time and a position n cycles before.

When the position n cycles before is used as reference coordinates, a pose change n cycles before with respect to the current point in time is θ, and the velocity at the current point in time is V, a velocity of a longitudinal component (longitudinal velocity) can be calculated as V sin θ and a velocity of a lateral component (lateral velocity) can be calculated as V cos θ. However, in processing step S201, when the velocity information is also stored in the memory, a configuration excluding processing step S301 can also be achieved.

In processing step S302, the longitudinal acceleration and the lateral acceleration are calculated from the velocity of the obstacle (longitudinal velocity and lateral velocity) calculated in processing step S301 based on the amount of velocity change. However, in the case of the configuration excluding processing step S301, the longitudinal acceleration and the lateral acceleration can be calculated from the velocity information stored in the memory in processing step S201. The acceleration is calculated in consideration of a relative relationship with the position of the own vehicle, and can be calculated by using an output value of the stereo camera or the radar.

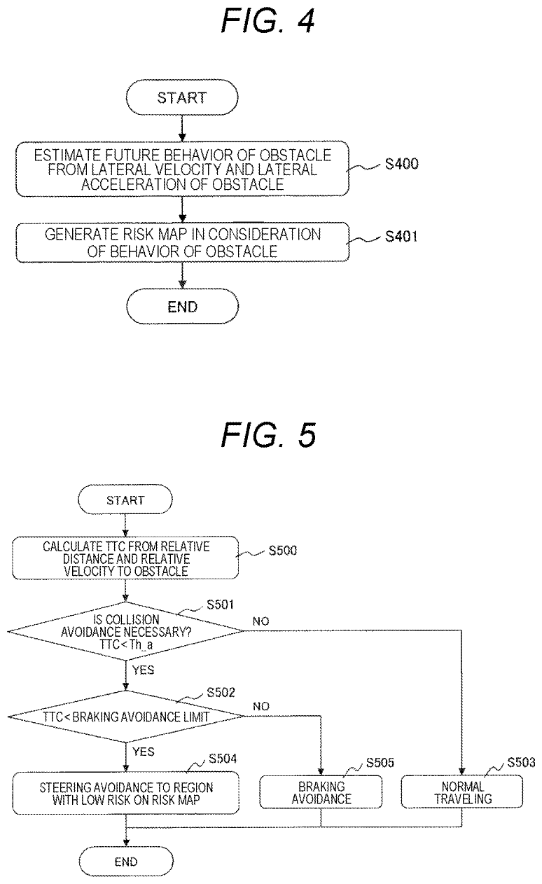

FIG. 4 illustrates a processing flow of the risk region determination unit 113. In first processing step S400 of the risk region determination unit 113, a future behavior of the obstacle is estimated based on the obstacle detection unit 111 and the obstacle behavior estimation unit 112.

In processing step S401, a risk map in which a risk is included in the map information is generated based on the behavior estimation result of the obstacle estimated in processing step S400. As a base map of the risk map, a spatial map capable of being generated by detecting a three-dimensional object based on information of the outside recognition sensor 30 may be used.

On the risk map, a direction in which the obstacle moves is predicted from a direction and a degree of the lateral acceleration of the obstacle and a direction and a degree of the lateral velocity, and a risk of a moving direction destination is increased. However, the risk of the risk map may be set by two patterns of 1: high or 0: low, or may be set with a likelihood (example: high of 1 to low of 0.5 to 0).

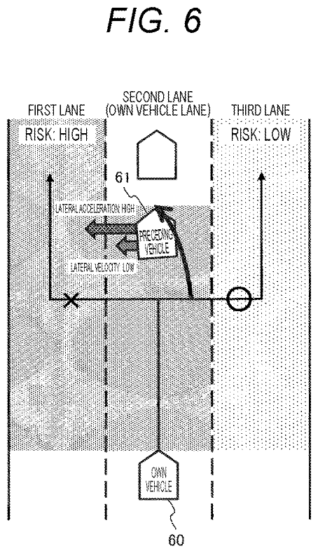

The risk map may be created in any format. However, the risk map includes, as the map information, for example, information indicating that for a road having first, second, and third lanes, the own vehicle is traveling along the second lane in the center, a region having a high risk is set in front of the second lane along which the own vehicle is traveling and in front of the first lane, and a low risk is set to the third lane in an example of FIG. 6 to be described later. On the risk map, the region having a high risk may be grasped as a region not only simply having the direction of the front and the side but also having a size including a distance to a preceding vehicle.

FIG. 5 illustrates a processing flow of the TTC calculation unit 114 and the collision avoidance operation control unit 115. In first processing step S500 of the TTC calculation unit 114 and the collision avoidance operation control unit 115, a time to collision TTC from a relative distance and a relative velocity between the own vehicle and the obstacle is calculated.

In processing step S501, it is determined whether collision avoidance is necessary for a scene based on the time to collision TTC calculated in processing step S500. A threshold value Th_a in processing step S501 can be arbitrarily set to the time to collision TTC when the intervention of collision avoidance control is required.

When it is determined in processing step S501 that the collision avoidance is “necessary (Yes)”, pieces of processing of processing step S502 and the subsequent steps are performed. On the other hand, when it is determined in processing step S501 that the collision avoidance is “unnecessary (No)”, processing step S503 is performed, and normal traveling is performed.

In processing step S502, when the time to collision TTC is equal to or less than a braking avoidance limit (Yes), processing step S504 is performed, and steering avoidance is performed to a region having a low risk on the risk map. On the other hand, when the time to collision TTC is equal to or greater than the braking avoidance limit (No), processing step S505 is performed, and braking avoidance is performed. A method for deciding a steering avoidance limit may be appropriately decided in consideration of an operating condition and the like, and the present invention does not limit the decision method.

According to the processing flow of FIG. 5, the collision avoidance operation control unit 115 executes, as an avoidance operation when it is determined that collision is not avoided (Yes in processing step S501), one of an operation of performing the braking avoidance using the braking device 12 (processing step S505) and an operation of performing the steering avoidance using the steering device 11 (processing step S504). Needless to say, the braking avoidance may be used together in performing the steering avoidance.

In the present invention, when the steering avoidance using the steering device 11 is performed (processing step S504), a direction of the steering avoidance is decided mainly from information on the acceleration of the obstacle. The direction of the steering avoidance is decided by adding information on the velocity to the information on the acceleration of the obstacle.

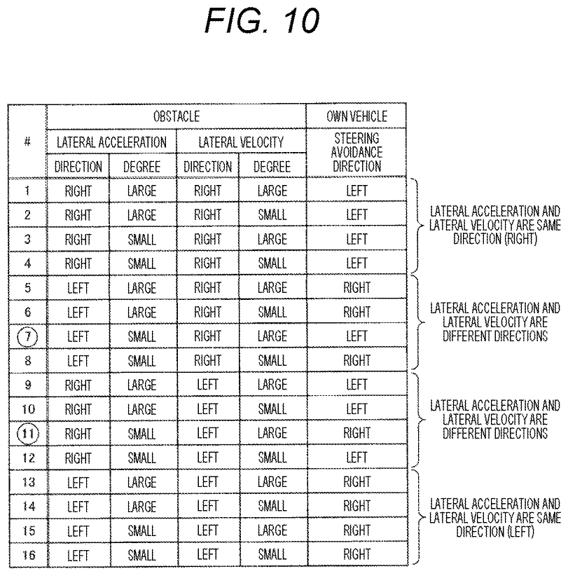

FIG. 10 is an example in which the steering avoidance direction of the own vehicle corresponding to the direction and degree of the lateral acceleration of the obstacle and the direction and degree of the lateral velocity when the own vehicle performs the steering avoidance for the obstacle. However, in FIG. 10, the directions of the lateral acceleration and the lateral velocity of the obstacle and the steering avoidance direction are represented by “left” and “right” for the sake of convenience.

In FIG. 10, the lateral acceleration and the lateral velocity of the obstacle are represented on a horizontal axis, and the directions (left and right) and degrees (large and small) of the lateral acceleration and the lateral velocity are further represented. The horizontal axis further represents the steering avoidance direction of the own vehicle. On a vertical axis, 16 combinations of the directions (left and right) and the degrees (large and small) of the lateral acceleration and the lateral velocity are described.

In this table, Cases 1 to 4 and Cases 13 to 16 show a case where the directions of the lateral acceleration and the lateral velocity are the same (the former is right and the latter is left), and show that the steering avoidance direction is a direction (the former is left and the latter is right) opposite to the directions of the lateral acceleration and the lateral velocity regardless of the combinations of the degrees (large and small) of the lateral acceleration and the lateral velocity. In short, the steering avoidance direction of the own vehicle is set to the direction opposite to that of the lateral acceleration in order to basically increase the risk in the region in the same direction as that of the lateral acceleration of the obstacle.

On the other hand, Cases 5 to 8 and Cases 9 to 12 show a case where the directions of the lateral acceleration and the lateral velocity are different (the former is left for the lateral acceleration and the latter is right for the lateral acceleration). The steering avoidance direction is basically opposite to the direction of the lateral acceleration in these cases, but only in Case 7 and Case 11, the steering avoidance direction is the same as the direction of the lateral acceleration. The steering avoidance direction is set to the left when the lateral acceleration is left in Case 7, and the steering avoidance direction is set to the right when the lateral acceleration is right in Case 11. In these Cases 7 and 11, a large lateral velocity acts in a direction opposite to a direction of a small lateral acceleration.

Here, in situations of Cases 7 and 11, that is, the lateral acceleration of the obstacle is small. However, when the steering avoidance direction of the own vehicle is generally set in the direction opposite to that of the lateral acceleration in consideration of a situation in which the lateral velocity is large in the direction opposite to that of the lateral acceleration (the obstacle suddenly starts to switch the moving direction and the like), a collision risk increases when the obstacle moves in the same direction as that of the steering avoidance direction of the own vehicle.

Thus, as illustrated in Case 7 and Case 11 of FIG. 10, when the degree of the lateral velocity of the obstacle is larger than the degree of the lateral acceleration, the steering avoidance is performed in the same direction as the direction of the lateral acceleration of the obstacle.

A typical example of FIG. 10 will be described with reference to FIGS. 6 to 8. These figures illustrate examples of dangerous events in a region in front of the own vehicle traveling in the central lane (second lane) of the three lanes.

According to the example of FIG. 6, a traffic jam suddenly occurs in front of a lane of the own vehicle while an own vehicle 60 is traveling along a second lane of an expressway. This example is a situation in which the time to collision TTC of the own vehicle 60 with respect to a preceding vehicle 61 that suddenly decelerates due to the traffic jam is equal to or less than the braking avoidance limit and the steering avoidance is necessary. At this time, the preceding vehicle 61 starts to move to the left lane in order to avoid the traffic jam.

In the example of FIG. 6, the collision avoidance operation determination unit 110 according to this embodiment operates as follows. First, the collision avoidance operation determination unit recognizes that the own vehicle 60 is traveling along the second lane of the three lanes of the expressway based on the map data of the database 20 and the GNSS 40.

The own vehicle 60 detects the preceding vehicle 61 present in front of the own vehicle 60 in the traveling direction by a stereo camera mounted at an upper portion of a windshield. The own vehicle 60 has outside recognition sensors such as a millimeter wave radar and a camera sensor mounted on a rear side and left and right sides of the own vehicle 60, and detects obstacles around the own vehicle 60.

The obstacle detection unit 111 detects and stores a position of the preceding vehicle 61 from a point in time when the preceding vehicle 61 starts to enter a detection range of the stereo camera mounted on the own vehicle 60.

Subsequently, it is assumed that the obstacle behavior estimation unit 112 calculates a lateral acceleration and a lateral velocity of the preceding vehicle 61 such that the lateral acceleration is small on the left and the lateral velocity is large on the left as illustrated in FIG. 6. The obstacle detection unit also detects that this event corresponds to Case 14 of FIG. 10.

Since the lateral acceleration and the lateral velocity of the preceding vehicle 61 occurs on the left, the risk region determination unit 113 determines that the preceding vehicle 61 is more likely to move to the first lane, and generates the risk map on which the risk of the first lane is set to high. In the example of FIG. 6, the risk is also set to high in the region of the second lane in front of the own vehicle.

Since the risk of the first lane is high, the collision avoidance operation control unit 115 sets the avoidance direction of the steering avoidance to the third lane having a low risk based on the risk map.

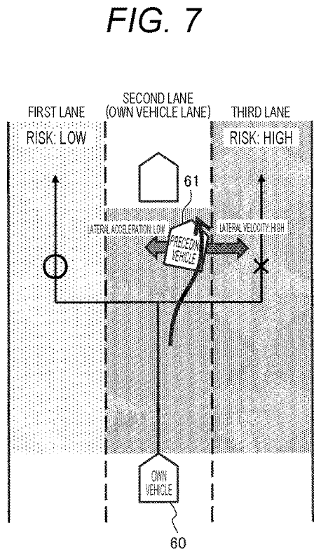

In the example of FIG. 7, a traffic jam occurs in front of the lane of the own vehicle while the own vehicle 60 is traveling along the second lane of the expressway. This example is a situation in which since the own vehicle 60 suddenly approaches the preceding vehicle 61, the time to collision TTC of the own vehicle with respect to the preceding vehicle 61 is equal to or less than the braking avoidance limit and the steering avoidance is necessary. At this time, the preceding vehicle 61 moves to the right in the second lane in order to see ahead of a traffic jam line, but suddenly steers to the left in order to immediately return to the lane.

For the example of FIG. 7, the collision avoidance operation determination unit 110 according to this embodiment operates as follows. First, the collision avoidance operation determination unit recognizes that the own vehicle 60 is traveling along the second lane of the three lanes of the expressway based on the map data of the database 20 and the GNSS 40. The own vehicle 60 detects the preceding vehicle present in front of the own vehicle 60 in the traveling direction by the stereo camera mounted on the upper portion of the windshield. The own vehicle 60 has outside recognition sensors such as a millimeter wave radar and a camera sensor mounted on a rear side and left and right sides of the own vehicle 60, and detects obstacles around the own vehicle 60.

The obstacle detection unit 111 detects and stores a position of the preceding vehicle 61 from a point in time when the preceding vehicle 61 starts to enter a detection range of the stereo camera mounted on the own vehicle 60.

Subsequently, it is assumed that the obstacle behavior estimation unit 112 calculates the lateral acceleration and the lateral velocity of the preceding vehicle 61 such that the lateral acceleration is small on the left and the lateral velocity is large on the right as illustrated in FIG. 7. The obstacle detection unit also detects that this event corresponds to Case 7 of FIG. 10.

Since the lateral acceleration of the preceding vehicle 61 occurs on the left but the lateral velocity thereof is large on the right, the preceding vehicle 61 is more likely to pop out to the third lane in this case. Accordingly, the risk region determination unit 113 determines that the preceding vehicle 61 is more likely to move to the third lane, and generates the risk map on which the risk of the third lane is set to high. In the example of FIG. 7, the risk is also set to high in the region of the second lane in front of the own vehicle.

Since the risk of the third lane is high, the collision avoidance operation control unit 115 sets the avoidance direction of steering avoidance to the first lane having a low risk based on the risk map.

Although the operation of the traveling control device has been described for the traffic jam of the expressway in the examples of FIGS. 6 and 7, the present invention is not limited to the traffic jam of the expressway. The present invention can be applied to a scene in which the preceding vehicle or another obstacle as a collision avoidance target is present even on a general road or an urban area and a large relative velocity to the obstacle is large.

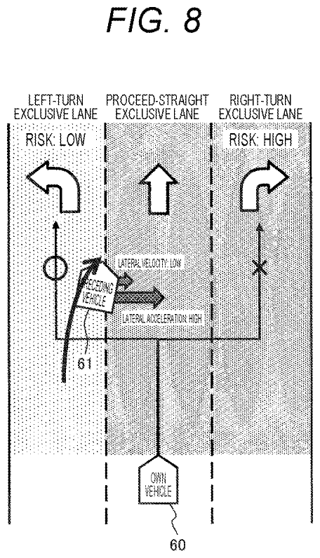

FIG. 8 illustrates a situation at an intersection on the general road. A system configuration of the vehicle is illustrated in FIG. 1.

FIG. 8 illustrates a scene in which the preceding vehicle 61 at a low velocity traveling along the left-turn exclusive lane cuts into the proceed-straight exclusive lane while the own vehicle 60 is traveling along the proceed-straight exclusive lane at an intersection having a left-turn exclusive lane, a proceed-straight exclusive lane, and a right-turn exclusive lane.

In this situation, the own vehicle 60 is traveling along the proceed-straight exclusive lane at the intersection. Immediately before the own vehicle 60 passes by the preceding vehicle 61 traveling along the left-turn exclusive lane at the low velocity, the preceding vehicle 61 starts to change the lane in front of the own vehicle 60. At this time, since a relative position and ae relative velocity are large, it is difficult to perform the avoidance due to braking, and thus, the avoidance due to steering needs to be performed.

The preceding vehicle 61 suddenly starts to move from the left-turn exclusive lane to the proceed-straight exclusive lane, and thus, the lateral acceleration is large on the right. Thus, the risk region determination unit determines that the preceding vehicle 61 is more likely to change the lane to the proceed-straight exclusive lane, and sets the risk of the proceed-straight exclusive lane to high. Since the lateral acceleration of the preceding vehicle 61 is large on the right, the risk region determination unit predicts that the lateral velocity also increases and the preceding vehicle is likely to move to the right-turn exclusive lane, and also sets the risk of the right-turn exclusive lane to high. The obstacle detection unit also detects that this event corresponds to Case 2 of FIG. 10.

Accordingly, the own vehicle 60 performs the steering avoidance to the left-turn exclusive lane having a low risk on the risk map.

### Second Embodiment

It has been described in the first embodiment that when the time to collision TTC with respect to the preceding vehicle exceeds the braking avoidance limit, the steering avoidance is performed. However, the present invention can be applied even when the time to collision TTC is before the braking avoidance limit.

Hereinafter, an example in which the present invention is applied to when the time to collision TTC is before the braking avoidance limit is illustrated.

In a case where a road surface friction coefficient of a wet road surface or an icy road surface is low, when the steering avoidance is performed by the same method as that in the first embodiment, the own vehicle is likely to spin. When the braking avoidance is performed, tires are locked, and a braking distance is extended. Accordingly, a case where the own vehicle collides with the obstacle in front is also considered, and thus, it is necessary to perform the steering avoidance.

In such an example, the above-mentioned problem can be solved by performing the steering avoidance with a certain margin in the time to collision TTC.

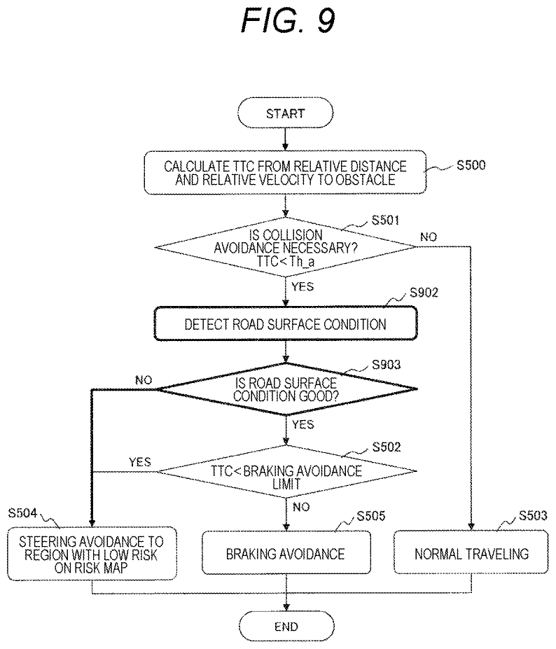

FIG. 9 illustrates a flow illustrating pieces of processing of the TTC calculation unit 114 and the steering avoidance determination control unit 115 according to a second embodiment after the risk map is generated based on the behavior of the obstacle in front. Since the flow is the same as that of FIG. 5 except that processing steps S902 and S903 are added in comparison of the flow of FIG. 9 with the flow of FIG. 5, a part of the description the operation overlapping with FIG. 5 is omitted.

In the processing flow of FIG. 9, the time to collision TTC is calculated from the relative distance and the relative velocity to the obstacle in first processing step S500, and when it is determined in processing step S501 that the collision avoidance is necessary for the scene, processing step S902 is performed. In the second embodiment, a threshold value of the time to collision TTC for performing the steering avoidance is changed depending on a road surface condition.

First, the road surface condition is detected in processing step S902. In the present invention, detection means of the road surface condition may be any means capable of grasping the road surface condition or the road surface friction coefficient. For example, estimation using reflection intensity information from a road surface from the information of the outside recognition sensor may be performed. Rotation speeds of four wheels of the vehicle may be compared and estimation may be performed from a deviation thereof. In addition, means for directly acquiring information on the road surface condition by road-to-vehicle communication or vehicle-to-vehicle communication may be used.

In processing step S903, collision avoidance means is determined based on the road surface condition detected in processing step S902. When it is determined in processing step S903 that the road surface condition is good (determined as “YES”), the steering avoidance or the braking avoidance is performed in processing step S504 according to the threshold value of the braking avoidance limit. Since the operations of processing step S504 and processing step S505 in this case are the same as those in the case of FIG. 5, the detailed description thereof will be omitted.

In the second embodiment of the present invention, when it is determined in processing step S903 that the road surface condition is bad (determined as “No”), the steering avoidance is performed based on the risk map generated in consideration of the behavior of the obstacle in processing step S504. In the steering avoidance when the road surface condition is bad, the vehicle needs to be controlled such that the vehicle does not slip due to the steering avoidance. In the second embodiment, in a case where it is determined as No in processing step S903 and processing step S504 is performed, a control command value given to the vehicle from the vehicle control command unit 120 is set as a control amount calculated based on information on the road surface friction coefficient or the like in the vehicle control command unit 120 (steering velocity and steering amount to the extent that the vehicle behavior does not diverge).

While the embodiments of the present invention have been described with reference to the drawings, the detailed configurations are not limited to these embodiments, and even changes in design without departing from the gist of the present invention are also included in the present invention.

For example, the aforementioned embodiments are described in detail in order to facilitate easy understanding of the present invention, and are not limited to necessarily include all the described components.

Some of the components of a certain embodiment can be substituted into the components of another embodiment, and the components of another embodiment can be added to the component of a certain embodiment.

In addition, other components can be added, removed, and substituted to, from, and into some of the components of the aforementioned embodiment.

Specifically, although it has been described that the collision avoidance operation determination unit operates for automatic driving (the acceleration and deceleration, the steering, and the like are controlled so as to follow a target traveling trajectory), the collision avoidance operation may be adaptive cruisecontrol (ACC), emergency automatic braking, lane keeping assist system, or the like or may be a collision avoidance operation in which two or more of these controls are combined.

Although it has been described in the first and second embodiments that the vehicle is used as an avoidance target object, the avoidance target object may be a moving object such as a pedestrian, a bicycle, or a motorcycle.

The present invention can be applied to even a case where since visibility is poor in the traveling direction due to weather conditions such as heavy rain, heavy fog, or backlight during traveling, an object suddenly appears in front of the eyes and steering avoidance is necessary.

A part or all of the aforementioned configurations, functions, and processing units of the present invention may be realized by hardware by designing an integrated circuit, for example.

Each of the aforementioned configurations and functions of the present invention may be realized by software by interpreting and executing a program that realizes each function by the processor. Information of programs, tables, and files for realizing the functions can be stored in a recording device such as a memory, a hard disk, or a solid state drive (SSD), or a recording medium such as an IC card, an SD card, or a DVD.

### REFERENCE SIGNS LIST

10 vehicle unit
11 steering device
12 braking device
20 database
30 outside recognition sensor
40 GNSS
60 own vehicle
61 preceding vehicle
100 traveling control device
110 collision avoidance operation determination unit
111 obstacle detection unit
112 obstacle behavior estimation unit
113 risk region determination unit
114 TTC calculation unit
115 collision avoidance operation control unit
120 vehicle control command unit

1. A traveling control device, comprising:
an acceleration calculation unit which obtains an acceleration of a target object from information of an outside recognition sensor;
a behavior estimation unit which estimates a behavior of the target object from the acceleration;
a TTC calculation unit which obtains a time to collision from the information of the outside recognition sensor;
a determination unit which determines a risk region based on outputs of the TTC calculation unit and the behavior estimation unit; and
a collision avoidance operation control unit which controls a collision avoidance operation for the target object based on a result of the determination unit.

2. The traveling control device according to claim 1, wherein the acceleration obtained by the acceleration calculation unit is a lateral acceleration in a traveling direction of an own vehicle.

3. The traveling control device according to claim 1, wherein the behavior estimation unit estimates the behavior of the target object according to a lateral acceleration of the target object and a strength thereof.

4. The traveling control device according to claim 3, further comprising
a velocity calculation unit which obtains a lateral velocity of the target object from the information of the outside recognition sensor,
wherein the behavior estimation unit estimates the behavior of the target object according to a lateral velocity of the target object and a strength thereof.

5. The traveling control device according to claim 1, wherein the collision avoidance operation control unit operates so as to avoid the risk region determined by the determination unit.

6. The traveling control device according to claim 1, further comprising
a road surface condition detection unit which detects a road surface condition from the information of the outside recognition sensor,
wherein the collision avoidance operation control unit performs the collision avoidance operation by changing a threshold value of the time to collision when steering avoidance is performed according to the road surface condition.

7. A vehicle comprising the traveling control device according to claim 1.

8. A traveling control method, comprising:
obtaining an acceleration of a target object from information of an outside recognition sensor;
estimating a behavior of the target object from the acceleration;
obtaining a time to collision;
determining a risk region based on the time to collision and the behavior of the target object; and
controlling a collision avoidance operation for the target object.

9. The traveling control method according to claim 8, wherein the collision avoidance operation for the target object is a steering avoidance operation, and a steering avoidance direction is a direction opposite to a direction of the acceleration.

10. The traveling control method according to claim 8, wherein
a velocity of the target object is obtained from the information of the outside recognition sensor,
the collision avoidance operation for the target object is a steering avoidance operation, and
a steering avoidance direction is decided by a direction of the acceleration and a direction of the velocity.

11. The traveling control method according to claim 10, wherein, when the directions and strengths of the acceleration and the velocity are obtained, the direction of the acceleration and the direction of the velocity are different, the strength of the velocity is large, and the strength of the acceleration is small, the steering avoidance direction is the direction of the acceleration.

12. The traveling control method according to claim 8, wherein the collision avoidance operation for the target object is a steering avoidance operation, and a road surface condition is reflected to the steering avoidance operation by determining the road surface condition.
